(19) United States
(12) Patent Application Publication
(10) Pub. No.: US 2025/0000169 A1
(43) Pub. Date: Jan. 2, 2025

(54) AEROSOL-GENERATING DEVICE AND SYSTEM COMPRISING AN INDUCTIVE HEATING DEVICE AND METHOD OF OPERATING SAME

(71) Applicant: Philip Morris Products S.A., Neuchatel (CH)

(72) Inventors: Maxime CHATEAU, Montlebon (FR); Markus KLEIN, Ligerz (CH)

(73) Assignee: Philip Morris Products S.A., Neuchatel (CH)

(21) Appl. No.: 18/710,632

(22) PCT Filed: Nov. 14, 2022
(86) PCT No.: PCT/EP2022/081704

§ 371 Date: May 16, 2024

(30) Foreign Application Priority Data
Nov. 25, 2021 (EP) 21210587.8

(51) Int. Cl. A24F 40/57; A24F 40/20; A24F 40/465; A24F 40/53

(52) U.S. Cl. CPC A24F 40/57; A24F 40/465; A24F 40/53; A24F 40/20

(57) ABSTRACT

A method for controlling aerosol production in an aerosol-generating device is provided, the device including an inductive heating arrangement and a power source to provide power to the heating arrangement, the method including: performing, during a first user operation mode of the device for producing an aerosol, a calibration process including measuring, to obtain a first safety parameter value, a safety parameter associated with a susceptor inductively coupled to the heating arrangement, the susceptor being configured to heat an aerosol-forming substrate, the calibration process further including a heating phase from a first calibration temperature to a second calibration temperature of the susceptor, and the safety parameter being a duration of the heating phase; and during a second user operation mode of the device, controlling power provided to the heating arrangement such that a temperature of the susceptor is adjusted based at least in part on the measured safety parameter.

The present disclosure relates to an inductive heating device for heating an aerosol-forming substrate. The present invention further relates to an aerosol-generating device comprising such an inductive heating device and a method for controlling aerosol production in the aerosol-generating device.

Aerosol-generating devices may comprise an electrically-operated heat source that is configured to heat an aerosol-forming substrate to produce an aerosol. It is important for aerosol-generating devices to accurately monitor and control the temperature of the electrically-operated heat source to ensure optimum generation and delivery of an aerosol to a user. In particular, it is important to ensure that the electrically-operated heat source does not overheat the aerosol-forming substrate as this may lead to generation of undesirable compounds as well as an unpleasant taste and aroma for the user.

It would be desirable to provide temperature monitoring and control of an inductive heating device that provides for reliable temperature regulation incorporating detection of overheating in order to efficiently implement safety mechanisms and ensure continued normal operation of the aerosol-generating device.

According to an embodiment of the present invention, there is provided a method for controlling aerosol production in an aerosol-generating device. The device comprises an inductive heating arrangement and a power source for providing power to the inductive heating arrangement. The method comprises: performing, during an first user operation mode of the aerosol-generating device for producing an aerosol, a calibration process comprising measuring, to obtain a first safety parameter value, a safety parameter associated with a susceptor inductively coupled to the inductive heating arrangement, wherein the susceptor is configured to heat an aerosol-forming substrate, wherein the calibration process comprises a heating phase from a first calibration temperature to a second calibration temperature of the susceptor, and wherein the safety parameter is a duration of the heating phase. The method further comprises, during a second user operation mode of the aerosol-generating device for producing an aerosol, controlling power provided to the inductive heating arrangement such that the temperature of the susceptor is adjusted based at least in part on the measured safety parameter.

Measuring the safety parameter value during the calibration process provides a method of incorporating a safety mechanism to prevent overheating into operation of the aerosol-generating device without affecting the user experience.

The method may further comprise performing one or more further calibration processes. The one or more further calibration processes comprise re-measuring the safety parameter associated with the susceptor. Controlling power provided to the inductive heating arrangement such that the temperature of the susceptor is adjusted based at least in part on the measured safety parameter may comprise: determining whether a value of the safety parameter re-measured during a respective further calibration process is greater than a threshold value, the threshold value based at least in part on the first safety parameter value; and if the value of the safety parameter re-measured during the respective further calibration process is greater than the threshold value, entering a safety operation mode of the aerosol-generating device. The threshold value may be at least 2 times the first safety parameter value.

The method may further comprise performing one or more further calibration processes, comprising re-measuring the safety parameter associated with the susceptor. Controlling power provided to the inductive heating arrangement such that the temperature of the susceptor is adjusted based at least in part on the measured safety parameter may further comprise: determining whether a value of a safety parameter re-measured during a respective further calibration process is greater than a threshold value, the threshold value based at least in part on a value of the safety parameter measured during a last calibration process prior to the respective calibration process; and if the value of the safety parameter re-measured during the respective further calibration process is greater than the threshold value, entering a safety operation mode of the aerosol-generating device. The threshold value may be at least 2 times a value of the safety parameter measured during the last calibration process prior to the respective calibration process.

Repeating the calibration process during operation of the device, comprising re-measuring the safety parameter provides for enhanced safety control throughout the user operation of the device for producing an aerosol. In addition, comparing the re-measured safety parameter value to a threshold value (which is a multiple of a previously-measured safety parameter value) provides for a more accurate determination of whether overheating may be occurring.

The one or more further calibration processes may be performed at predetermined time intervals. Each of the predetermined time intervals may be between 20 seconds and 50 seconds.

The method may further comprise monitoring one of a value of current associated with a susceptor, a conductance value associated with the susceptor and a resistance value associated with the susceptor, wherein the further calibration processes may be performed in response to detecting that a change of the monitored value of current, conductance value or resistance value is greater than a threshold change value.

Repeating the calibration process, including re-measuring the safety parameter when the apparent current, resistance or conductance of the susceptor appears to be unstable, means that malfunctions can be detected early, thereby further enhancing the effectiveness of the safety mechanism.

Controlling power provided to the inductive heating arrangement such that the temperature of the susceptor is adjusted based at least in part on the measured safety parameter may comprise comparing the first safety parameter value to a predetermined value associated with the susceptor; and entering the safety operation mode or entering the second user operation mode based on the outcome of the comparison. Entering the safety operation mode or entering the second user operation mode based on the outcome of the comparison may comprise: entering the safety operation mode if the first safety parameter value is greater than the predetermined value; and entering the second user operation mode if the first safety parameter value is less than the predetermined value.

This ensures detection of a malfunction that would lead to overheating as early as possible as well as the accuracy of the first measured safety parameter value.

Entering the safety operation mode may comprise reducing the power provided to the inductive heating arrangement. Entering the safety operation mode may comprise stopping the provision of power to the inductive heating device. Entering the safety operation mode may comprise automatically switching off the aerosol-generating device. Entering the safety operation mode may comprise generating a signal to alert a user that an error condition has occurred.

The susceptor may comprise a first susceptor material having a first Curie temperature and a second susceptor material having a second Curie temperature, wherein the second Curie temperature is lower than the first Curie temperature, and wherein the second calibration temperature corresponds to the second Curie temperature of the second susceptor material. The first susceptor material may be a ferrous metal and the second susceptor material may comprise nickel.

The method may further comprise, during the second user operation mode of the aerosol-generating device for producing an aerosol, maintaining the temperature of the susceptor between the first calibration temperature and the second calibration temperature.

Maintaining the temperature of the susceptor between the first calibration temperature and the second calibration temperature enables more accurate temperature control, thereby improving the user experience.

Performing the calibration process may further comprise measuring a first calibration value corresponding to the first calibration temperature and a second calibration value corresponding to the second calibration temperature, wherein the first calibration value and the second calibration value are values of current, resistance values or conductance values, and wherein controlling power provided to the inductive heating arrangement comprises adjusting the temperature of the susceptor based at least in part on the first calibration value and the second calibration value.

Controlling power and hence susceptor temperature based on the first calibration value and the second calibration value provides an efficient method for accurate temperature control.

According to an embodiment of the present invention, there is provided an aerosol-generating device. The aerosol-generating device comprises: a power source for providing a DC supply voltage and a DC current; and power supply electronics connected to the power source. The power supply electronics comprise: a DC/AC converter; and an inductor connected to the DC/AC converter for the generation of an alternating magnetic field, when energized by an alternating current from the DC/AC converter. The inductor is couplable to a susceptor, wherein the susceptor is configured to heat an aerosol-forming substrate. The aerosol-generating device further comprises a controller configured to: perform, during an first user operation mode of the aerosol-generating device for producing an aerosol, a calibration process comprising measuring, to obtain a first safety parameter value, a safety parameter associated with a susceptor inductively coupled to the inductive heating arrangement, wherein the susceptor is configured to heat an aerosol-forming substrate, wherein the calibration process comprises a heating phase from a first calibration temperature to a second calibration temperature of the susceptor, and wherein the safety parameter is a duration of the heating phase; and during a second user operation mode of the aerosol-generating device for producing an aerosol, control power provided to the inductive heating arrangement such that the temperature of the susceptor is adjusted based at least in part on the measured safety parameter.

The controller may be further configured to perform one or more further calibration processes, the one or more further calibration processes comprising re-measuring the safety parameter associated with the susceptor. Controlling power provided to the inductive heating arrangement such that the temperature of the susceptor is adjusted based at least in part on the measured safety parameter may comprise: determining whether a value of a safety parameter re-measured during a respective further calibration process is greater than a threshold value, the threshold value based at least in part on the first safety parameter value; and if the value of the safety parameter re-measured during a respective further calibration process is greater than the threshold value, the controller is configured to enter a safety operation mode of the aerosol-generating device. The threshold value may be at least 2 times the first safety parameter value.

The controller may be further configured to perform one or more further calibration processes, comprising re-measuring the safety parameter associated with the susceptor. Controlling power provided to the inductive heating arrangement such that the temperature of the susceptor is adjusted based at least in part on the measured safety parameter may comprise: determining whether a value of a safety parameter re-measured during a respective further calibration process is greater than a threshold value, the threshold value based at least in part on a value of a safety parameter measured during a last calibration process prior to the respective calibration process; and if the value of the safety parameter re-measured during the respective further calibration process is greater than the threshold value, the controller is configured to enter a safety operation mode of the aerosol-generating device. The threshold value may be at least 2 times the value of the safety parameter measured during the last calibration process prior to the respective calibration process.

The controller may be configured to perform the one or more further calibration processes at predetermined time intervals. Each of the predetermined time intervals may be between 20 seconds and 50 seconds.

The controller may be further configured to monitor one of a value of current associated with a susceptor, a conductance value associated with the susceptor and a resistance value associated with the susceptor, wherein the controller is configured to perform the further calibration processes in response to detecting that a change of the monitored value of current, conductance value or resistance value is greater than a threshold change value.

Controlling power provided to the inductive heating arrangement such that the temperature of the susceptor is adjusted based at least in part on the measured safety parameter may comprise: comparing the first safety parameter value to a predetermined value associated with the susceptor, wherein the controller is configured to enter the safety operation mode or the second user operation mode based on the outcome of the comparison. Entering the safety operation mode or entering the second user operation mode based on the outcome of the 20 comparison may comprise: entering the safety operation mode if the first safety parameter value is greater than the predetermined value; and entering the second user operation mode if the first safety parameter value is less than the predetermined value.

Entering the safety operation mode may comprise reducing the power provided to the inductive heating arrangement. Entering the safety operation mode may comprise stopping the provision of power to the inductive heating device. Entering the safety operation mode may comprise automatically switching off the aerosol-generating device. Entering the safety operation mode may comprise generating a signal to alert a user that an error condition has occurred.

The susceptor may comprise a first susceptor material having a first Curie temperature and a second susceptor material having a second Curie temperature, wherein the second Curie temperature is lower than the first Curie temperature, and wherein the second calibration temperature corresponds to the second Curie temperature of the second susceptor material.

The first susceptor material may be a ferrous metal and the second susceptor material may comprise nickel.

The controller may be further configured to, during the second user operation mode of the aerosol-generating device for producing an aerosol, maintain the temperature of the susceptor between the first calibration temperature and the second calibration temperature.

Performing the calibration process may further comprise measuring a first calibration value corresponding to the first calibration temperature and a second calibration value corresponding to the second calibration temperature, wherein the first calibration value and the second calibration value are values of current, resistance values or conductance values. Controlling power provided to the inductive heating arrangement may comprise adjusting the temperature of the susceptor based at least in part on the first calibration value and the second calibration value.

According to an embodiment of the present invention, there is provided an aerosol-generating system, comprising: the aerosol-generating device described above; and an aerosol-generating article, wherein the aerosol-generating article comprises the aerosol-forming substrate and the susceptor in thermal contact with the aerosol-forming substrate.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, “aerosol-cooling element” refers to a component of an aerosol-generating article located downstream of the aerosol-forming substrate such that, in use, an aerosol formed by volatile compounds released from the aerosol-forming substrate passes through and is cooled by the aerosol cooling element before being inhaled by a user. An aerosol cooling element has a large surface area, but causes a low pressure drop. Filters and other mouthpieces that produce a high pressure drop, for example filters formed from bundles of fibers, are not considered to be aerosol-cooling elements. Chambers and cavities within an aerosol-generating article are not considered to be aerosol cooling elements.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

The invention is defined in the claims. However, below there is provided a non-exhaustive list of non-limiting examples. Any one or more of the features of these examples may be combined with any one or more features of another example, embodiment, or aspect described herein.

Example Ex1: A method for controlling aerosol production in an aerosol-generating device, the device comprising an inductive heating arrangement and a power source for providing power to the inductive heating arrangement, and the method comprising: performing, during an first user operation mode of the aerosol-generating device for producing an aerosol, a calibration process comprising measuring, to obtain a first safety parameter value, a safety parameter associated with a susceptor inductively coupled to the inductive heating arrangement, wherein the susceptor is configured to heat an aerosol-forming substrate, wherein the calibration process comprises a heating phase from a first calibration temperature to a second calibration temperature of the susceptor, and wherein the safety parameter is a duration of the heating phase; and during a second user operation mode of the aerosol-generating device for producing an aerosol, controlling power provided to the inductive heating arrangement such that the temperature of the susceptor is adjusted based at least in part on the measured safety parameter.

Example Ex2: The method according to example Ex1, further comprising performing one or more further calibration processes, the one or more further calibration processes comprising re-measuring the safety parameter associated with the susceptor, wherein controlling power provided to the inductive heating arrangement such that the temperature of the susceptor is adjusted based at least in part on the measured safety parameter, comprises: determining whether a value of the safety parameter re-measured during a respective further calibration process is greater than a threshold value, the threshold value based at least in part on the first safety parameter value; and if the value of the safety parameter re-measured during the respective further calibration process is greater than the threshold value, entering a safety operation mode of the aerosol-generating device.

Example Ex3: The method according to example Ex2, wherein the threshold value is at least 2 times the first safety parameter value.

Example Ex4: The method according to the example of example Ex1, further comprising: performing one or more further calibration processes, comprising re-measuring the safety parameter associated with the susceptor, wherein controlling power provided to the inductive heating arrangement such that the temperature of the susceptor is adjusted based at least in part on the measured safety parameter, comprises: determining whether a value of a safety parameter re-measured during a respective further calibration process is greater than a threshold value, the threshold value based at least in part on a value of the safety parameter measured during a last calibration process prior to the respective calibration process; and if the value of the safety parameter re-measured during the respective further calibration process is greater than the threshold value, entering a safety operation mode of the aerosol-generating device.

Example Ex5: The method according to example Ex4, wherein the threshold value is at least 2 times a value of the safety parameter measured during the last calibration process prior to the respective calibration process.

Example Ex6: The method according to one of examples Ex2 to Ex5, wherein the one or more further calibration processes are performed at predetermined time intervals.

Example Ex7: The method according to example Ex6, wherein each of the predetermined time intervals is between 20 seconds and 50 seconds.

Example Ex8: The method according to one of examples Ex2 to Ex5, further comprising monitoring one of a value of current associated with a susceptor, a conductance value associated with the susceptor and a resistance value associated with the susceptor, wherein the further calibration processes are performed in response to detecting that a change of the monitored value of current, conductance value or resistance value is greater than a threshold change value.

Example Ex9: The method according to one of examples Ex1 to Ex8, wherein controlling power provided to the inductive heating arrangement such that the temperature of the susceptor is adjusted based at least in part on the measured safety parameter comprises: comparing the first safety parameter value to a predetermined value associated with the susceptor; and entering the safety operation mode or entering the second user operation mode based on the outcome of the comparison.

Example Ex10: The method according to example Ex9, wherein entering the safety operation mode or entering the second user operation mode based on the outcome of the comparison comprises: entering the safety operation mode if the first safety parameter value is greater than the predetermined value; and entering the second user operation mode if the first safety parameter value is less than the predetermined value.

Example Ex11: The method according to one of examples Ex2 to Ex10, wherein entering the safety operation mode comprises reducing the power provided to the inductive heating arrangement.

Example Ex12: The method according to one of examples Ex2 to Ex10, wherein entering the safety operation mode comprises stopping the provision of power to the inductive heating device.

Example Ex13: The method according to one of examples Ex2 to Ex10, wherein entering the safety operation mode comprises automatically switching off the aerosol-generating device.

Example Ex14: The method according to one of examples Ex2 to Ex13, wherein entering the safety operation mode comprises generating a signal to alert a user that an error condition has occurred.

Example Ex15: The method according to one of examples Ex1 to Ex14, wherein the susceptor comprises a first susceptor material having a first Curie temperature and a second susceptor material having a second Curie temperature, wherein the second Curie temperature is lower than the first Curie temperature, and wherein the second calibration temperature corresponds to the second Curie temperature of the second susceptor material.

Example Ex16: The method according to example Ex15, wherein the first susceptor material is a ferrous metal and the second susceptor material comprises nickel.

Example Ex17: The method according to one of examples Ex1 to Ex16, further comprising, during the second user operation mode of the aerosol-generating device for producing an aerosol, maintaining the temperature of the susceptor between the first calibration temperature and the second calibration temperature.

Example Ex18: The method according to one of examples Ex1 to Ex17, wherein performing the calibration process further comprises measuring a first calibration value corresponding to the first calibration temperature and a second calibration value corresponding to the second calibration temperature, wherein the first calibration value and the second calibration value are values of current, resistance values or conductance values, and wherein controlling power provided to the inductive heating arrangement comprises adjusting the temperature of the susceptor based at least in part on the first calibration value and the second calibration value.

Example Ex19: An aerosol-generating device comprising: a power source for providing a DC supply voltage and a DC current; power supply electronics connected to the power source, the power supply electronics comprising: a DC/AC converter; an inductor connected to the DC/AC converter for the generation of an alternating magnetic field, when energized by an alternating current from the DC/AC converter, the inductor being couplable to a susceptor, wherein the susceptor is configured to heat an aerosol-forming substrate; and a controller configured to: perform, during an first user operation mode of the aerosol-generating device for producing an aerosol, a calibration process comprising measuring, to obtain a first safety parameter value, a safety parameter associated with a susceptor inductively coupled to the inductive heating arrangement, wherein the susceptor is configured to heat an aerosol-forming substrate, wherein the calibration process comprises a heating phase from a first calibration temperature to a second calibration temperature of the susceptor, and wherein the safety parameter is a duration of the heating phase; and during a second user operation mode of the aerosol-generating device for producing an aerosol, control power provided to the inductive heating arrangement such that the temperature of the susceptor is adjusted based at least in part on the measured safety parameter.

Example Ex20: The aerosol-generating device according to example Ex19, wherein the controller is further configured to perform one or more further calibration processes, the one or more further calibration processes comprising re-measuring the safety parameter associated with the susceptor, and wherein controlling power provided to the inductive heating arrangement such that the temperature of the susceptor is adjusted based at least in part on the measured safety parameter, comprises: determining whether a value of a safety parameter re-measured during a respective further calibration process is greater than a threshold value, the threshold value based at least in part on the first safety parameter value; and if the value of the safety parameter re-measured during a respective further calibration process is greater than the threshold value, the controller is configured to enter a safety operation mode of the aerosol-generating device.

Example Ex21: The aerosol-generating device according to example Ex20, wherein the threshold value is at least 2 times the first safety parameter value.

Example Ex22: The aerosol-generating device according to example Ex19, wherein the controller is further configured to perform one or more further calibration processes, comprising re-measuring the safety parameter associated with the susceptor, and wherein controlling power provided to the inductive heating arrangement such that the temperature of the susceptor is adjusted based at least in part on the measured safety parameter, comprises: determining whether a value of a safety parameter re-measured during a respective further calibration process is greater than a threshold value, the threshold value based at least in part on a value of a safety parameter measured during a last calibration process prior to the respective calibration process; and if the value of the safety parameter re-measured during the respective further calibration process is greater than the threshold value, the controller is configured to enter a safety operation mode of the aerosol-generating device.

Example Ex23: The aerosol-generating device according to example Ex22, wherein the threshold value is at least 2 times the value of the safety parameter measured during the last calibration process prior to the respective calibration process.

Example Ex24: The aerosol-generating device according to one of examples Ex20 to Ex23, wherein the controller is configured to perform the one or more further calibration processes at predetermined time intervals.

Example Ex25: The aerosol-generating device according to example Ex24, wherein each of the predetermined time intervals is between 20 seconds and 50 seconds.

Example Ex26: The aerosol-generating device according to one of examples Ex20 to Ex23, wherein the controller is further configured to monitor one of a value of current associated with a susceptor, a conductance value associated with the susceptor and a resistance value associated with the susceptor, wherein the controller is configured to perform the further calibration processes in response to detecting that a change of the monitored value of current, conductance value or resistance value is greater than a threshold change value.

Example Ex27: The aerosol-generating device according to one of example Ex19 to Ex26, wherein controlling power provided to the inductive heating arrangement such that the temperature of the susceptor is adjusted based at least in part on the measured safety parameter comprises: comparing the first safety parameter value to a predetermined value associated with the susceptor, wherein the controller is configured to enter the safety operation mode or the second user operation mode based on the outcome of the comparison.

Example Ex28: The aerosol-generating device according to example Ex27, wherein entering the safety operation mode or entering the second user operation mode based on the outcome of the comparison comprises: entering the safety operation mode if the first safety parameter value is greater than the predetermined value; and entering the second user operation mode if the first safety parameter value is less than the predetermined value.

Example Ex29: The aerosol-generating device according to one of example Ex20 to Ex28, wherein entering the safety operation mode comprises reducing the power provided to the inductive heating arrangement.

Example Ex30: The aerosol-generating device according to one of examples Ex20 to Ex28, wherein entering the safety operation mode comprises stopping the provision of power to the inductive heating device.

Example Ex31: The aerosol-generating device according to one of examples Ex20 to Ex28, wherein entering the safety operation mode comprises automatically switching off the aerosol-generating device.

Example Ex32: The aerosol-generating device according to one of examples Ex20 to Ex31, wherein entering the safety operation mode comprises generating a signal to alert a user that an error condition has occurred.

Example Ex33: The aerosol-generating device according to one of examples Ex19 to Ex32, wherein the susceptor comprises a first susceptor material having a first Curie temperature and a second susceptor material having a second Curie temperature, wherein the second Curie temperature is lower than the first Curie temperature, and wherein the second calibration temperature corresponds to the second Curie temperature of the second susceptor material.

Example Ex34: The aerosol-generating device according to example Ex33, wherein the first susceptor material is a ferrous metal and the second susceptor material comprises nickel.

Example Ex35: The aerosol-generating device according to one of examples Ex19 to Ex34, wherein the controller is further configured to, during the second user operation mode of the aerosol-generating device for producing an aerosol, maintain the temperature of the susceptor between the first calibration temperature and the second calibration temperature.

Example Ex36: The method according to one of examples Ex19 to Ex35, wherein performing the calibration process further comprises measuring a first calibration value corresponding to the first calibration temperature and a second calibration value corresponding to the second calibration temperature, wherein the first calibration value and the second calibration value are values of current, resistance values or conductance values, and wherein controlling power provided to the inductive heating arrangement comprises adjusting the temperature of the susceptor based at least in part on the first calibration value and the second calibration value.

Example Ex37: An aerosol-generating system, comprising: the aerosol-generating device according to one of examples Ex19 to Ex36; and an aerosol-generating article, wherein the aerosol-generating article comprises the aerosol-forming substrate and the susceptor in thermal contact with the aerosol-forming substrate.

Examples will now be further described with reference to the figures in which:

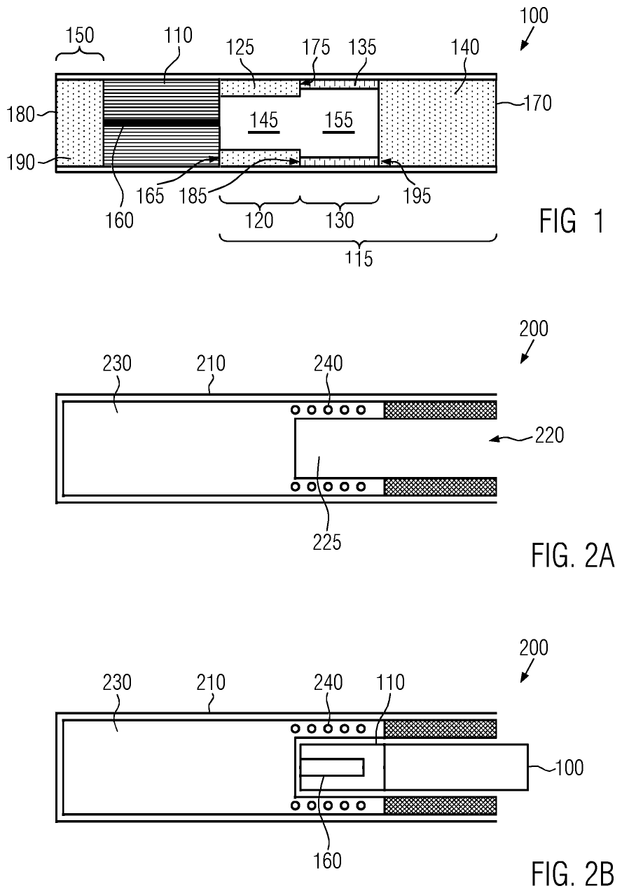

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

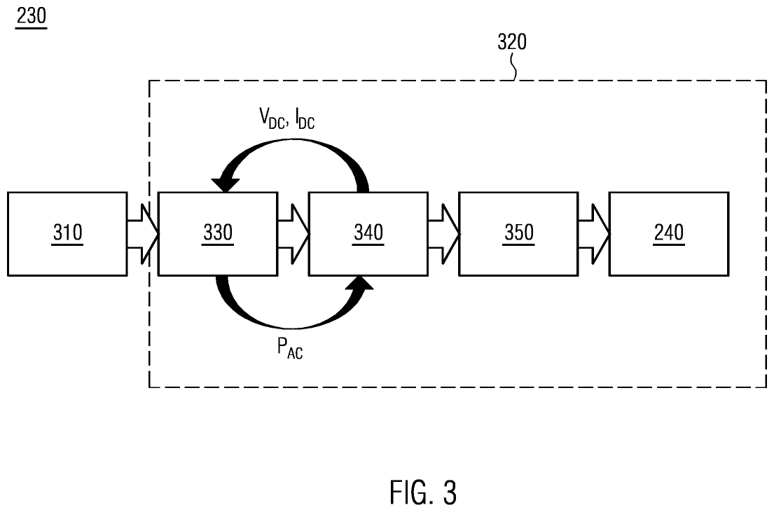

FIG. 3 is a block diagram showing an inductive heating device of the aerosol-generating device described in relation to FIG. 2;

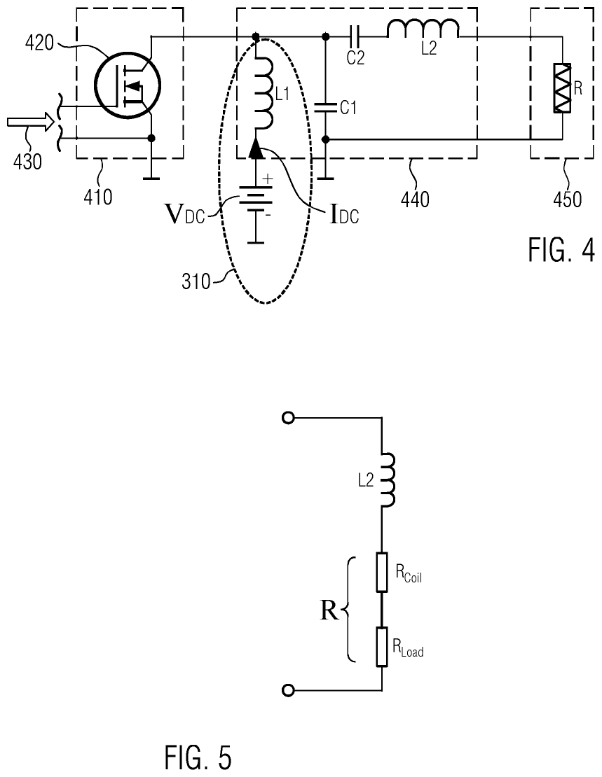

FIG. 4 is a schematic diagram showing electronic components of the inductive heating device described in relation to FIG. 3;

FIG. 5 is a schematic diagram on an inductor of an LC load network of the inductive heating device described in relation to FIG. 4;

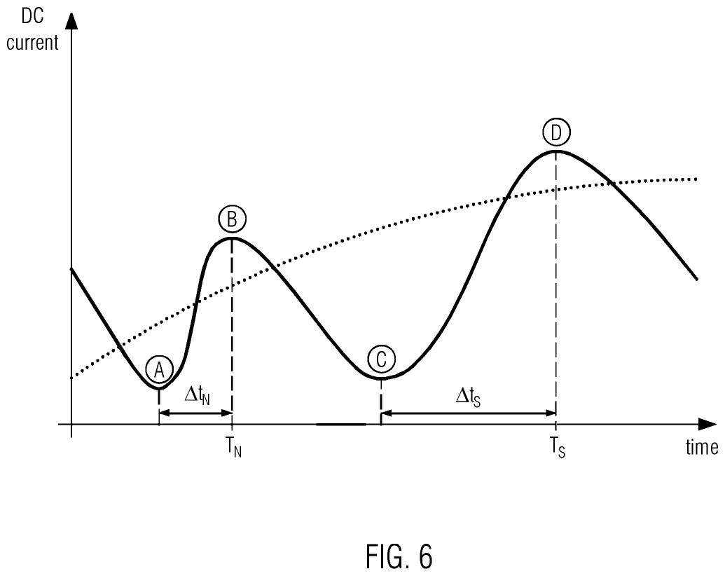

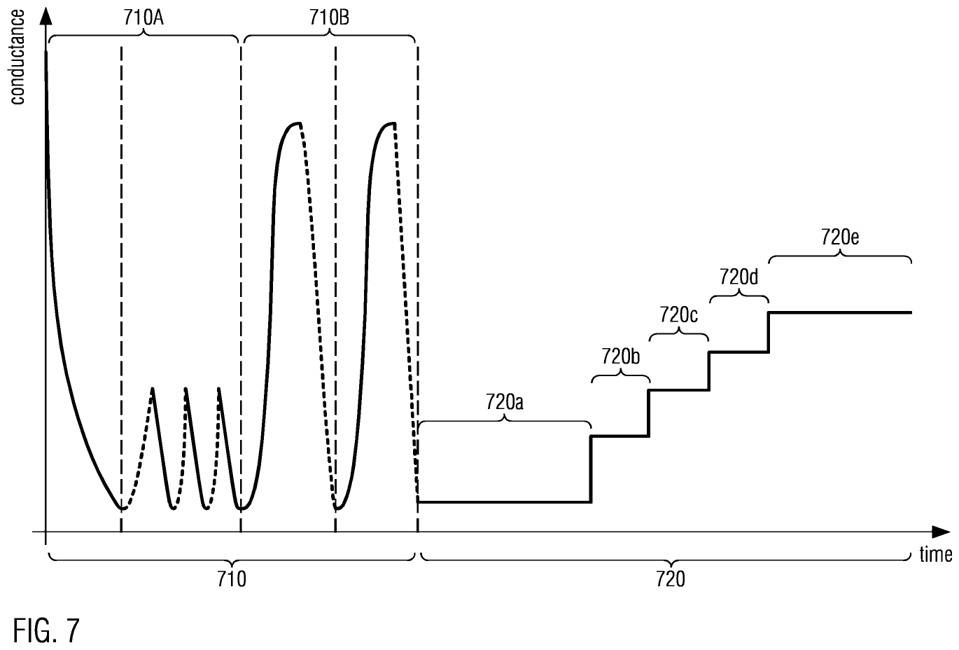

FIG. 6 is a graph of DC current vs. time illustrating the remotely detectable current changes that occur when the susceptor materials undergo their respective phase transitions associated with their respective Curie points; FIG. 7 illustrates a temperature profile of the susceptor during operation of the aerosol-generating device;

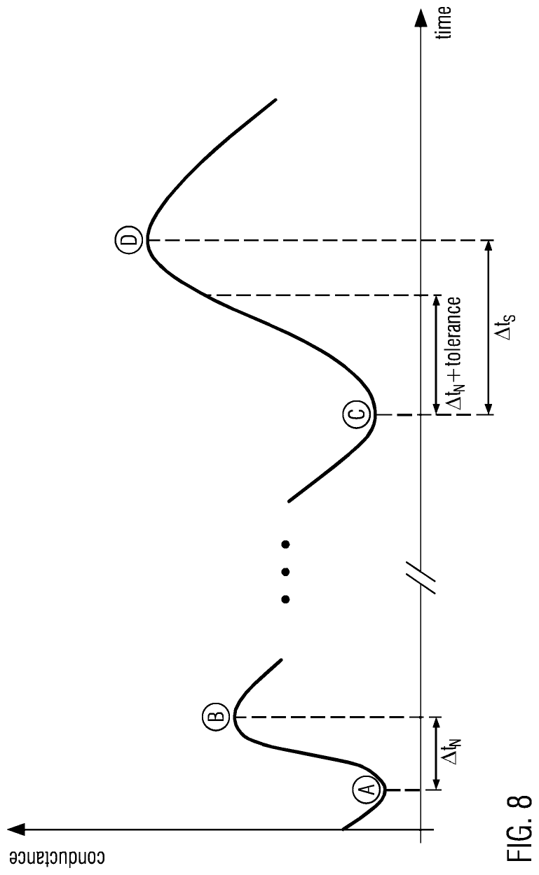

FIG. 8 is a graph of conductance vs. time illustrating the remotely detectable conductance changes that may occur if monitoring of the conductance is interrupted during calibration; and

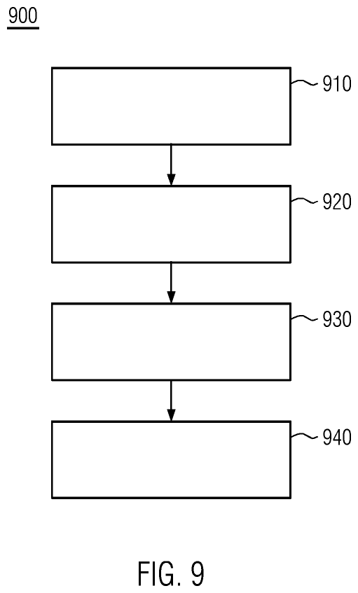

FIG. 9 is a flow diagram showing a method for controlling aerosol-production in the aerosol-generating device of FIG. 2.

The drawings are not to be construed as limiting the application to only the illustrated and described examples of how they can be made and used. In particular, the drawings are to be understood as being not to scale.

FIG. 1 illustrates a schematic side sectional view of an aerosol-generating article 100. The aerosol-generating article 100 comprises a rod of aerosol-forming substrate 110 and a downstream section 115 at a location downstream of the rod of aerosol-forming substrate 110. The aerosol-generating article 100 comprises an upstream section 150 at a location upstream of the rod of aerosol-forming substrate 110. Thus, the aerosol-generating article 100 extends from an upstream or distal end 180 to a downstream or mouth end 170. In use, air is drawn through the aerosol-generating article 100 by a user from the distal end 180 to the mouth end 170.

The downstream section 115 comprises a support element 120 located immediately downstream of the rod of aerosol-forming substrate 110, the support element 120 being in longitudinal alignment with the rod 110. The upstream end of the support element 120 abuts the downstream end of the rod of aerosol-forming substrate 110. In addition, the downstream section 115 comprises an aerosol-cooling element 130 located immediately downstream of the support element 120, the aerosol-cooling element 130 being in longitudinal alignment with the rod 110 and the support element 120. The upstream end of the aerosol-cooling element 130 abuts the downstream end of the support element 120. In use, volatile substances released from the aerosol-forming substrate 110 pass along the aerosol-cooling element 130 towards the mouth end 170 of the aerosol-generating article 100. The volatile substances may cool within the aerosol-cooling element 130 to form an aerosol that is inhaled by the user.

The support element 120 comprises a first hollow tubular segment 125. The first hollow tubular segment 125 is provided in the form of a hollow cylindrical tube made of cellulose acetate. The first hollow tubular segment 125 defines an internal cavity 145 that extends all the way from an upstream end 165 of the first hollow tubular segment 125 to a downstream end 175 of the first hollow tubular segment 125.

The aerosol-cooling element 130 comprises a second hollow tubular segment 135. The second hollow tubular segment 135 is provided in the form of a hollow cylindrical tube made of cellulose acetate. The second hollow tubular segment 135 defines an internal cavity 155 that extends all the way from an upstream end 185 of the second hollow tubular segment 135 to a downstream end 195 of the second hollow tubular segment 135. In addition, a ventilation zone (not shown) is provided at a location along the second hollow tubular segment 135. A ventilation level of the aerosol-generating article 100 is about 25 percent.

The downstream section 115 further comprises a mouthpiece 140 positioned immediately downstream of the aerosol-cooling element 130. As shown in the drawing of FIG. 1, an upstream end of the mouthpiece 140 abuts the downstream end 195 of the aerosol-cooling element 130. The mouthpiece 140 is provided in the form of a cylindrical plug of low-density cellulose acetate.

The aerosol-generating article 100 further comprises an elongate susceptor 160 within the rod of aerosol-generating substrate 110. In more detail, the susceptor 160 is arranged substantially longitudinally within the aerosol-forming substrate 110, such as to be approximately parallel to the longitudinal direction of the rod 110. As shown in the drawing of FIG. 1, the susceptor 160 is positioned in a radially central position within the rod and extends effectively along the longitudinal axis of the rod 110.

The susceptor 160 extends all the way from an upstream end to a downstream end of the rod of aerosol-forming substrate 110. In effect, the susceptor 160 has substantially the same length as the rod of aerosol-forming substrate 110. The susceptor 160 is located in thermal contact with the aerosol-forming substrate 110, such that the aerosol-forming substrate 110 is heated by the susceptor 160 when the susceptor 160 is heated.

The upstream section 150 comprises an upstream element 190 located immediately upstream of the rod of aerosol-forming substrate 110, the upstream element 190 being in longitudinal alignment with the rod 110. The downstream end of the upstream element 190 abuts the upstream end of the rod of aerosol-forming substrate. This advantageously prevents the susceptor 160 from being dislodged. Further, this ensures that the consumer cannot accidentally contact the heated susceptor 160 after use. The upstream element 190 is provided in the form of a cylindrical plug of cellulose acetate circumscribed by a stiff wrapper.

The susceptor 160 comprises at least two different materials. The susceptor 160 comprises at least two layers: a first layer of a first susceptor material disposed in physical contact with a second layer of a second susceptor material. The first susceptor material and the second susceptor material each have a Curie temperature. In this case, the Curie temperature of the second susceptor material is lower than the Curie temperature of the first susceptor material. The first susceptor material may be aluminum, iron, stainless steel or other ferrous metal. The second susceptor material may be nickel or a nickel alloy. According to a preferred embodiment, the first susceptor material is stainless steel and the second susceptor material is a nickel alloy comprising a majority of nickel.

The susceptor 160 may be formed by electroplating at least one patch of the second susceptor material onto a strip of the first susceptor material. The susceptor 160 may be formed by cladding a strip of the second susceptor material to a strip of the first susceptor material.

The aerosol-generating article 100 illustrated in FIG. 1 is designed to engage with an aerosol-generating device, such as the aerosol-generating device 200 illustrated in FIG. 2A, for producing an aerosol. The aerosol-generating device 200 comprises a housing 210 having a cavity 220 configured to receive the aerosol-generating article 100 and an inductive heating device 230 configured to heat an aerosol-generating article 100 for producing an aerosol. FIG. 2B illustrates the aerosol-generating device 200 when the aerosol-generating article 100 is inserted into the cavity 220.

The inductive heating device 230 is illustrated as a block diagram in FIG. 3. The inductive heating device 230 comprises a DC power source 310 and a heating arrangement 320 (also referred to as power supply electronics). The heating arrangement 320 comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 160, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 110 of the aerosol-generating article 100 is located adjacent to the inductor 240 so that the susceptor 160 of the aerosol-generating article 100 is located within this alternating magnetic field. When the alternating magnetic field penetrates the susceptor 160, the alternating magnetic field causes heating of the susceptor 160. For example, eddy currents are generated in the susceptor 160 which is heated as a result. Further heating is provided by magnetic hysteresis losses within the susceptor 160. The heated susceptor 160 heats the aerosol-forming substrate 110 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 160.

FIG. 6 illustrates the relationship between the DC current I_{DC} drawn from the power source 310 over time as the temperature of the susceptor 160 (indicated by the dotted line) increases. More specifically, FIG. 6 illustrates the remotely-detectable DC current changes that occur when the susceptor materials undergo respective phase transitions associated with their respective Curie points, where the Curie temperature of the second susceptor material is lower than the Curie temperature of the first susceptor material. The DC current I_{DC} drawn from the power source 310 is measured at an input side of the DC/AC converter 340. For the purpose of this illustration, it may be assumed that the voltage V_{DC} of the power source 310 remains approximately constant.

As the susceptor 160 is inductively heated, the apparent resistance of the susceptor 160 increases. This increase in resistance is observed as a decrease in the DC current I_{DC} drawn from the power source 310, which at constant voltage decreases as the temperature of the susceptor 160 increases. The high frequency alternating magnetic field provided by the inductor 240 induces eddy currents in close proximity to the susceptor surface, an effect that is known as the skin effect. The resistance in the susceptor 160 depends in part on the electrical resistivity of the first susceptor material, the resistivity of the second susceptor material and in part on the depth of the skin layer in each material available for induced eddy currents, and the resistivity is in turn temperature dependent.

As the second susceptor material reaches its Curie temperature, it loses its magnetic properties. This causes an increase in the skin layer available for eddy currents in the second susceptor material, which causes a decrease in the apparent resistance of the susceptor 160. The result is a temporary increase in the detected DC current I_{DC}. Then, when the skin depth of the second susceptor material begins to increase, the resistance begins to fall. This is seen as the valley labelled A in FIG. 6.

As heating continues, the current continues to increase until the maximum skin depth is reached, which coincides with the point where the second susceptor material has lost its spontaneous magnetic properties. This point is at the Curie temperature (T_{N}) of the second susceptor material and is seen as the hill labelled B in FIG. 6. At this point, the second susceptor material has undergone a phase change from a ferro-magnetic or ferri-magnetic state to a paramagnetic state. at the temperature at point B is a known temperature because the Curie temperature is an intrinsic material-specific temperature.

If the inductor 240 continues to generate an alternating magnetic field (i.e. power to the DC/AC converter 340 is not interrupted) after the Curie temperature of the second susceptor material has been reached, the eddy currents generated in the susceptor 160 will run against the resistance of the susceptor 160, whereby Joule heating in the susceptor 160 will continue, and thereby the resistance will increase again (and the current will start falling again) until the temperature of the susceptor begins to approach the Curie temperature of the first susceptor material, shown as the valley labelled C in FIG. 6. This causes an increase in the skin layer available for eddy currents in the first susceptor material, which causes a decrease in the apparent resistance of the susceptor 160. The result is a temporary increase in the detected DC current I_{DC} until the maximum skin depth is reached, which coincides with the point where the first susceptor material has lost its spontaneous magnetic properties. This point is called the Curie temperature (T_{S}) and is seen as the hill labelled D in FIG. 6. At this point the first susceptor material has undergone a phase change from a ferro-magnetic or ferri-magnetic state to a paramagnetic state and the susceptor 160 is at a known temperature.

Therefore, if the susceptor is heated for long enough, both of the susceptor materials undergo a reversible phase transition when heated through the (known) temperature range between their respective valley and hill, as shown in FIG. 6. However, for the purpose of heating the aerosol-generating substrate to form an aerosol, heating through the full temperature range up to the Curie temperature of the first susceptor material is to be avoided, because the Curie temperature of stainless steel, depending on the type of steel, is above 700 degrees Celsius. Hence, heating to these temperatures would initiate combustion of the aerosol generating substrate, which is to be avoided because it will lead to generation of smoke instead of a water-based aerosol, and thereby off tastes and numerous undesired components resulting from the combustion process.

The second susceptor material is chosen such that the temperature range between valley A and hill B is suitable for heating the aerosol-forming substrate 110 of the aerosol-generating article 100 to generate an aerosol. As can be seen from FIG. 6, the apparent resistance of the susceptor 160, and hence the start and end of the phase transition of the second susceptor material, can be remotely detected by monitoring the DC current I_{DC} drawn from the power source 310. Alternatively, the apparent resistance of the susceptor 160, and hence the start and end of the phase transition of the second susceptor material, can be remotely detected by monitoring a conductance value (where conductance is defined as the ratio of the DC current I_{DC} to the DC supply voltage V_{DC}) or a resistance value (where resistance is defined as the ratio of the DC supply voltage V_{DC} to the DC current I_{DC}). At least the DC current I_{DC} drawn from the power source 310 is monitored by the controller 330. Although the DC supply voltage V_{DC} is known, preferably both the DC current I_{DC} drawn from the power source 310 and the DC supply voltage V_{DC} are monitored. The DC current I_{DC}, the conductance value and the resistance value may be referred to as power source parameters.

As the susceptor 160 is heated, a first turning point at valley A in FIG. 6 (corresponding to a local minimum for current and a local maximum for resistance) corresponds to the start of the phase transition. Then, as the susceptor continues to be heated, a second turning point at hill B in FIG. 6 (corresponding to a local maximum for current and a local minimum for resistance) corresponds to the end of the phase transition.

Furthermore as can be seen from FIG. 6, the apparent resistance of the susceptor 160 (and correspondingly the current I_{DC} drawn from the power source 310) may vary with the temperature of the susceptor 160 in a strictly monotonic relationship over certain ranges of temperature of the susceptor 160, such as between the valley and the hill. The strictly monotonic relationship allows for an unambiguous determination of the temperature of the susceptor 160 from a determination of the apparent resistance (R) or apparent conductance (1/R). This is because each determined value of the apparent resistance is representative of only one single value of the temperature, so that there is no ambiguity in the relationship. The monotonic relationship of the temperature of the susceptor 160 and the apparent resistance in the temperature range in which the second susceptor material undergoes the reversible phase transition allows for the determination and control of the temperature of the susceptor 160 and thus for the determination and control of the temperature of the aerosol-forming substrate 110.

The controller 330 regulates the supply of power provided to the heating arrangement 320 based on a power supply parameter. The heating arrangement 320 may comprise a current sensor (not shown) to measure the DC current I_{DC}. The heating arrangement may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power P_{AC} to the inductor 240.

The controller 330 may control the temperature of the susceptor 160 by maintaining the measured power supply parameter value at a target value corresponding to a target operating temperature of the susceptor 160. The controller 330 may use any suitable control loop to maintain the measured power supply parameter at the target value, for example by using a proportional-integral-derivative control loop.

In order to take advantage of the strictly monotonic relationship between the apparent resistance (or apparent conductance) of the susceptor 160 and the temperature of the susceptor 160, during user operation for producing an aerosol, the power supply parameter measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill B in the current plot in FIG. 6). The first calibration temperature is a temperature greater than or equal to the temperature of the susceptor at which the skin depth of the second susceptor material begins to increase, leading to a temporary lowering of the resistance (the valley A in the current plot in FIG. 6). Thus, the first calibration temperature is a temperature greater than or equal to the temperature at maximum permeability of the second susceptor material. The first calibration temperature is at least 50 degrees Celsius lower than the second calibration temperature. At least the second calibration value may be determined by calibration of the susceptor 160, as will be described in more detail below. The first calibration value and the second calibration value may be stored as calibration values in a memory of the controller 330.

Although the power supply parameter will have a polynomial dependence of the temperature, which for most metallic susceptor materials can be approximated to a third degree polynomial dependence for our purposes, the first and the second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the power supply parameter is regulated according to the first calibration value and the second calibration value, through linear equations.

For example, if the first and the second calibration values are conductance values, the target conductance value corresponding to the target operating temperature may be given by:

$${G}_{Target} = {G}_{L o w e r} + ( x \times Δ G )$$

where ΔG is the difference between the first conductance value and the second conductance value and x is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 160, and simultaneously the DC current I_{DC} and optionally the DC supply voltage V_{DC} may be measured, preferably every millisecond for a period of 100 milliseconds.

For example, if the conductance or current is monitored by the controller 330 for adjusting the susceptor temperature, when the conductance or current reaches or exceeds a value corresponding to the target operating temperature for adjusting the susceptor temperature, the duty cycle of the switching transistor 410 is reduced. If the resistance is monitored by the controller 330 for adjusting the susceptor temperature, when the resistance reaches or goes below a value corresponding to the target operating temperature, the duty cycle of the switching transistor 410 is reduced. For example, the duty cycle of the switching transistor 410 may be reduced to about 10%. In other words, the switching transistor 410 may be switched to a mode in which it generates pulses only every 10 milliseconds for a duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 160 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 160. The probing pulses are isolated power pulses having an intensity such not to heat the susceptor 160 but rather to obtain a feedback on the power supply parameter and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to perform a calibration process in order to obtain the calibration values at which the power supply parameter is measured at known temperatures of the susceptor 160. The known temperatures of the susceptor may be the first calibration temperature corresponding to the first calibration value and the second calibration temperature corresponding to the second calibration value. The calibration process is performed each time the user operates the aerosol-generating device 200. For example, the controller 330 may be configured to enter a calibration mode for performing the calibration process when the user switches on the aerosol-generating device. The controller 330 may be programmed to enter the calibration mode each time the user inserts an aerosol-generating article 100 into an aerosol-generating device 200. Thus, the calibration process is performed during a first user operation mode of the aerosol-generating device, before user operation of the aerosol-generating device 200 to generate an aerosol.

During a heating phase of the calibration process, the controller 330 controls the DC/AC converter 340 to continuously or continually supply power to the inductor 240 in order to heat the susceptor 160. The controller 330 monitors the power supply parameter by measuring the current I_{DC} drawn by the power supply and, optionally the power supply voltage V_{DC}. As discussed above in relation to FIG. 6, as the susceptor 160 is heated, the measured current decreases until a first turning point (valley A) is reached and the current begins to increase. This first turning point corresponds to a local minimum conductance or current value (a local maximum resistance value). The controller 330 may record the power supply parameter at the first turning point as the first calibration value.

The conductance or resistance values may be determined based on the measured current I_{DC} and the measured voltage V_{DC}. Alternatively, it may be assumed that the power supply voltage V_{DC}, which is a known property of the power source 310, is approximately constant. The temperature of the susceptor 160 at the first calibration value is referred to as the first calibration temperature. Preferably, the first calibration temperature is between 150 degrees Celsius and 350 degrees Celsius. More preferably, when the aerosol-forming substrate 110 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the controller 330 continues to monitor the power supply parameter until a second turning point is reached (hill B). The second turning point corresponds to a maximum current (corresponding to the Curie temperature of the second susceptor material) before the measured current begins to decrease. This turning point corresponds to a local maximum conductance or current value (a local minimum resistance value). The controller 330 records the power supply parameter value at the second turning point as the second calibration value. The temperature of the susceptor 160 at the second calibration value is referred to as the second calibration temperature. Preferably, the second calibration temperature is between 200 degrees Celsius and 400 degrees Celsius. When the maximum is detected, the controller 330 enters a cooling phase of the calibration process and controls the DC/AC converter 340 to interrupt provision of power to the inductor 240, resulting in a decrease in susceptor 160 temperature and a corresponding decrease in measured current.

Due to the shape of the graph, this process of continuously heating the susceptor 160 to obtain the first calibration value and the second calibration value may be repeated at least once during the calibration mode. After interrupting provision of power to the inductor 240, the controller 330 continues to monitor the power supply parameter until a third turning point is observed. The third turning point corresponds to a second minimum conductance or current value (a second maximum resistance value). When the third turning point is detected, the controller 330 controls the DC/AC converter 340 to continuously provide power to the inductor 240 until a fourth turning point in the monitored power supply parameter is observed. The fourth turning point corresponds to a second maximum conductance or current value (a second minimum resistance value). The controller 330 stores the power supply parameter value that is measured at the third turning point as the first calibration value and the power supply parameter value measured the fourth turning point as the second calibration value. The repetition of the measurement of the turning points corresponding to minimum and maximum measured current significantly improves the subsequent temperature regulation during user operation of the device for producing an aerosol. Preferably, controller 330 regulates the power based on the power supply parameter values obtained from the second maximum and the second minimum, this being more reliable because the heat will have had more time to distribute within the aerosol-forming substrate 110 and the susceptor 160.

The controller 330 is configured to detect the turning points by measuring a sequence of power source parameter values. With reference to FIG. 6, the sequence of measured power source parameter values will form a curve, with each value being greater than or less than the previous value. The controller 330 is configured to measure the calibration value at the point where the curve begins to flatten. In other words, the controller 330 records the calibration values when the difference between consecutive power supply parameter values is below a predetermined threshold value.

Further, during the first user operation mode, in order to further improve the reliability of the calibration process, the controller 310 may be optionally programmed to perform a pre-heating process before the calibration process. For example, if the aerosol-forming substrate 110 is particularly dry or in similar conditions, the calibration may be performed before heat has spread within the aerosol-forming substrate 110, reducing the reliability of the calibration values. If the aerosol-forming substrate 110 were humid, the susceptor 160 takes more time to reach the valley temperature (due to water content in the substrate 110).

To perform the pre-heating process, the controller 330 is configured to continuously provide power to the inductor 240. As described above with respect to FIG. 6, the measured current starts decreasing with increasing susceptor 160 temperature until a turning point corresponding to minimum measured current is reached. At this stage, the controller 330 is configured to wait for a predetermined period of time to allow the susceptor 160 to cool before continuing heating. The controller 330 therefore controls the DC/AC converter 340 to interrupt provision of power to the inductor 240. After the predetermined period of time, the controller 330 controls the DC/AC converter 340 to provide power until the turning point corresponding to the minimum measured current is reached again. At this point, the controller controls the DC/AC converter 340 to interrupt provision of power to the inductor 240 again. The controller 330 again waits for the same predetermined period of time to allow the susceptor 160 to cool before continuing heating. This heating and cooling of the susceptor 160 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 110 is dry, the first current minimum of the pre-heating process is reached within the pre-determined period of time and the interruption of power will be repeated until the end of the predetermined time period. If the aerosol-forming substrate 110 is humid, the first current minimum of the pre-heating process will be reached towards the end of the pre-determined time period. Therefore, performing the pre-heating process for a predetermined duration ensures that, whatever the physical condition of the substrate 110, the time is sufficient for the substrate 110 to reach the minimum operating temperature, in order to be ready to feed continuous power and reach the first maximum. This allows a calibration as early as possible, but still without risking that the substrate 110 would not have reached the valley beforehand.

Further, the aerosol-generating article 100 may be configured such that the current minimum is always reached within the predetermined duration of the pre-heating process. If the current minimum is not reached within the pre-determined duration of the pre-heating process, this may indicate that the aerosol-generating article 100 comprising the aerosol-forming substrate 110 is not suitable for use with the aerosol-generating device 200. For example, the aerosol-generating article 100 may comprise a different or lower-quality aerosol-forming substrate 110 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to cease operation of the aerosol-generating device 200.

As mentioned above, as the first stage of the calibration process, the pre-heating process may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200. During normal operation when the aerosol-generating device 200 is generating an aerosol, the controller 330 will be operating in the second user operation mode for heating the aerosol-forming substrate 110 to generate an aerosol. The controller 330 may be programmed to enter at predefined intervals, from the second user operation mode, a recalibration mode for performing at least part of the calibration process. The predefined intervals may be predefined time intervals or a predetermined number of puffs. Additionally, or alternatively, the controller 330 may be programmed to enter the calibration mode for repeating at least part of the calibration process in response to detection that the power supply parameter has become unstable.

Performing at least part of the calibration process may comprise re-measuring both the calibration value at both turning points (illustrated as the hill B and the valley A in FIG. 6). To perform a further calibration process in the recalibration mode, the controller 330 monitors the power source parameter associated with the susceptor 160 by measuring the current I_{DC} drawn by the power supply and, optionally the power supply voltage V_{DC}. Because the minimum operating temperature of the aerosol-generating device is greater than the first calibration temperature, as the susceptor 160 is heated during the further iterations of the calibration process, the measured current I_{DC} increases until a turning point is reached and the current I_{DC} begins to decrease. This turning point corresponds to the end point of the reversible phase transition of the susceptor 160, observed as a local maximum conductance or current value (a local minimum resistance value). The controller 330 records the power source parameter value at the turning point as the re-measured second calibration value.

Once the turning point has been reached, the controller 330 controls the DC/AC converter 340 to reduce the power provided to the inductor 240 until another turning point is observed. This another turning point corresponds to the end point of the reversible phase transition of the susceptor, observed as a local minimum conductance or current value (a local maximum resistance value). The controller 330 records the power source parameter value at the another turning point as the re-measured first calibration value.

FIG. 7 is a graph of conductance against time showing a heating profile of the susceptor 160. The graph illustrates two consecutive user modes: a first user operation mode 710 that is entered when the user switches on the aerosol-generating device 200 and a second user operation mode 720 corresponding to user operation of the aerosol-generating device 200 to produce an aerosol. As described above, in the first user operation mode 710, the controller 330 may operate in a calibration mode 710B to perform the calibration process. Optionally, in the first user operation mode 710, the controller 330 may operate in a pre-heating mode 710A to perform the pre-heating process. It is to be understood that FIG. 7 is not shown to scale. Specifically, the first user operation mode 710 has a shorter duration that the second user operation mode 720. For example, the first user operation mode 710 may have a duration of between 5 seconds and 30 seconds, preferably between 10 and 20 seconds. The second user operation mode 720 may have a duration of between 140 and 340 seconds.

Further, although FIG. 7 is illustrated as a graph of conductance against time, it is to be understood that the controller 330 may be configured to control the heating of the susceptor 160 during the first user operation mode 710 and the second user operation mode 720 based on measured resistance or current as described above. Indeed, although the techniques to control of the heating of the susceptor during the first user operation mode 710 and the second user operation mode 720 have been described above based on a determined conductance value or a determined resistance value associated with the susceptor, it is to be understood that the techniques described above could be performed based on a value of current measured at the input of the DC/AC converter 340.

As can be seen from FIG. 7, the heating of the aerosol-forming substrate 110 to produce an aerosol during the second user operation mode 720 comprises a plurality of conductance steps, corresponding to a plurality of temperature steps from a first operating temperature of the susceptor 160 to a second operating temperature of the susceptor 160. The first operating temperature of the susceptor is a temperature at which the aerosol-forming substrate 110 forms an aerosol so that an aerosol is formed during each temperature step. Preferably, the first operating temperature of the susceptor is a minimum temperature at which the aerosol-forming substrate will form an aerosol in a sufficient volume and quantity for a satisfactory experience when inhaled a user. The second operating temperature of the susceptor is the temperature at maximum temperature at which it is desirable for the aerosol-forming substrate to be heated for the user to inhale the aerosol.

The first operating temperature of the susceptor 160 is greater than or equal to the first calibration temperature of the susceptor 160, corresponding to the first calibration value (the valley A of the current plot shown in FIG. 6). The first operating temperature may be between 150 degrees Celsius and 330 degrees Celsius. The second operating temperature of the susceptor 160 is less than or equal to the second calibration temperature of the susceptor 160, corresponding to the second calibration value at the Curie temperature of the second susceptor material (the hill B of the current plot shown in FIG. 6). The second operating temperature may be between 200 degrees Celsius and 400 degrees Celsius. The difference between the first operating temperature and the second operating temperature is at least 50 degree Celsius. It is to be understood that the number of temperature steps illustrated in FIG. 7 is exemplary and that second heating phase 720 comprises at least three consecutive temperature steps, preferably between two and fourteen temperature steps, most preferably between three and eight temperature steps. Each temperature step may have a predetermined duration. Preferably the duration of the first temperature step is longer than the duration of subsequent temperature steps. The duration of each temperature step is preferably longer than 10 seconds, preferably between 30 seconds and 200 seconds, more preferably between 40 seconds and 160 seconds. The duration of each temperature step may correspond to a predetermined number of user puffs. Preferably, the first temperature step corresponds to four user puffs and each subsequent temperature step corresponds to one user puff.

For the duration of each temperature step, the temperature of the susceptor 160 is maintained at a target operating temperature corresponding to the respective temperature step. Thus, for the duration of each temperature step, the controller 330 controls the provision of power to the heating arrangement 320 such that the measured power source parameter is maintained at a target value corresponding to the target operating temperature of the respective temperature step, where the target value is determined with reference to the first calibration value and the second calibration value as described above.

As an example, the second heating phase 720 may comprise five temperature steps: a first temperature step 720a having a duration of 160 seconds and a target conductance value of G_{Target}=G_{Lower}+ (0.09× ΔG), a second temperature step 720b having a duration of 40 seconds and a target conductance value of G_{Target}=G_{Lower}+ (0.25× ΔG), a third temperature step 720c having a duration of 40 seconds and a target conductance value of G_{Target}=G_{Lower}+ (0.4× ΔG), a fourth temperature step 720d having a duration of 40 seconds and a target conductance value Of G_{Target}=G_{Lower}+ (0.56× ΔG) and a fifth temperature step 720e having a duration of 85 seconds and a target conductance value of G_{Target}=G_{Lower}+ (0.75× ΔG). These temperature steps may correspond to temperatures of 330 degrees Celsius, 340 degrees Celsius, 345 degrees Celsius, 355 degrees Celsius and 380 degrees Celsius.

Thus, control of the operating temperature of the susceptor 160 for generating an aerosol depends on the first calibration value (corresponding to the first calibration temperature) and the second calibration value (corresponding to the second calibration temperature) measured during the calibration process. In particular, referring back of FIG. 6, the control of the operating temperature of the susceptor 160 depends on the detection of the hill B corresponding to the Curie temperature of the second susceptor material. As described above, the heating phase of the calibration process ends when the controller 330 interrupts the provision of power to the inductor to reduce the temperature of the susceptor 160. This is triggered by the detection of the second turning point (the hill B) in FIG. 6.

However, if for any reason hill B is not detected, the controller 330 would not disable the heating pulses and would continue to heat the susceptor 160 beyond the Curie temperature of the second susceptor material. This would then result in overheating of the aerosol-forming substrate. If the heating were to continue, the valley C would be detected by the controller 330. Once valley C is detected, further heating of the susceptor 160 would be triggered until hill D is detected, corresponding to the Curie temperature of the first susceptor material. The temperature of the susceptor 160 would then be regulated based on the temperatures corresponding to valley C and hill D. This temperature range is significantly higher than the temperature range between the hill B and the valley A associated with the second susceptor material.

This is illustrated in FIG. 8, which shows a hypothetical scenario in which the controller 330 does not detect hill B during the calibration process due to an event (indicated by the three dots) that results in the controller 330 not detecting the valley A and hill B that are associated with the second susceptor material. Such an event may be a change of the apparent susceptor impedance response detected by the controller, for example as a result of the aerosol-generating article 110 (and hence the susceptor 160) moving from its correct position during use.

In order to prevent such an overheating scenario from occurring, the controller 330 is configured to measure an additional parameter (referred to herein as the safety parameter) during the calibration process, in addition to the first and second calibration values.

As can be seen from both FIG. 6 and FIG. 8, due to the properties of the first susceptor material and the second susceptor material, investigations have shown that a time between reaching hill B from valley A (Δt_{N}) is always less than a time between reaching hill D from valley C (Δt_{S}).

Accordingly, the controller 330 is configured to measure, during the calibration process, the duration of time between detection of the first turning point at valley A and the second turning point at hill B. If the duration of time is longer than a threshold value, the controller 330 is configured to enter a safety operation mode to prevent overheating. The threshold value is based on the properties of the second susceptor material and is measured during the calibration mode during the first heating phase. Additionally, or alternatively, the threshold value is a predetermined value that is stored by the controller 330.

During the calibration mode 710B, a timer associated with the controller 330 is triggered when the first turning point is detected. The timer measures the time until the second turning point is detected. The duration of time measured by the timer is stored by the controller 330 as a first value of the safety parameter, corresponding to Δt_{N}. The controller 330 then determines and stores a first threshold value for the duration of time of subsequent calibration processes based on the first value of the safety parameter. The threshold value is defined as:

$$threshold value = Δ {t}_{N} + tolerance .$$

The purpose of the tolerance is to prevent false detection of overheating, where such a false detection may occur if the threshold value was set to the safety parameter value. At the same time, the tolerance is chosen based on the properties of the first susceptor material, i.e. the threshold value is chosen to be large enough to avoid false overheating detections, but yet smaller than the typical time intervals Δt_{S}. This is illustrated in FIG. 8. The tolerance may be at least 0.5× Δt_{N}, preferably the value of Δt_{N}. In other words, the threshold value may be a multiple of Δt_{N}.

During the second use operation mode 720, when the controller 330 repeats the calibration process, the safety parameter is re-measured by the controller 330 in addition to the re-measuring of the first and second calibration values. The re-measured value of the safety parameter is compared to the stored first threshold value. If the time duration corresponding to the safety parameter value being measured during re-calibration is greater than the threshold value, the controller is configured to enter a safety operation mode of the aerosol-generating device. In the safety operation mode, the controller 330 is configured to prevent further heating of the susceptor, for example, by stopping the provision of power to the inductor or immediately switching off the aerosol-generating device 200. In the safety operation mode, the controller 330 may be configured to generate an alert or alarm for a user to indicate that the safety operation mode has been entered.

To re-measure the safety parameter value, the controller 330 is configured to measure a time from the detection of the first turning point of the calibration process. Comparing the re-measured safety parameter value to the threshold value may comprise comparing the time elapsed since the detection of the first turning point to the threshold value. The controller 330 may then enter the safety operation mode as soon as the time elapsed since the detection of the first turning point reaches the threshold value.

When the controller 330 performs the calibration process for the first time during the second heating phase 720, the threshold value may be based on the first safety parameter value measured during the calibration mode 710B. During subsequent further calibration processes during the second heating phase 720, the respective re-measured safety parameter values may be compared to the first safety parameter value measured during the calibration mode.

The safety parameter values re-measured during each subsequent calibration process during the second heating phase will be shorter in duration than the preceding re-measured safety calibration values because the aerosol-forming substrate 110 surrounding the susceptor 160 increases in temperature over time and, since the temperatures at the turning points (the hill and valley) are fixed, the time needed to raise the temperature from the first turning point to the second turning point shortens over time. Accordingly, the respective re-measured safety parameter values may be compared to the latest measured safety parameter value. For example, the safety parameter value measured during a second calibration process performed the second heating phase 720 may be compared to the safety parameter value measured during the first calibration process performed in the second heating phase.

It can be assumed that the measurement of the safety parameter during the calibration process performed during the calibration mode 710B runs properly and that the first value of the safety parameter is correctly measured. This is because the aerosol-generating article 100 is at a lower temperature at the start of the calibration mode and because the aerosol-forming substrate 110 is not depleted.

However, during use, the user may inadvertently move the position of the aerosol-generating article 110. Hence, to further increase safety, a predetermined threshold value may be stored by the controller 330, where the controller 330 is configured to compare the first measured value of the safety parameter to the predetermined threshold value. Comparing the re-measured safety parameter value to the predetermined threshold value may comprise comparing the time elapsed since the detection of the first turning point to the predetermined threshold value. The controller 330 may then enter the safety operation mode as soon as the time elapsed since the detection of the first turning point reaches the predetermined threshold value.

The predetermined threshold value may be determined during manufacture of the aerosol-generating article or based on known properties of the susceptor materials. The controller 330 may be configured to enter the second heating mode 720 if the first safety parameter value is less than the predetermined threshold value and to enter the safety operation mode if the first safety parameter value is greater than the predetermined threshold value.

FIG. 9 is a flow diagram of a method 900 for controlling aerosol-production in an aerosol-generating device 200. As described above, the controller 330 may be programmed to perform the method 900.

The method begins at step 910, where the controller 330 detects user operation of the aerosol-generating device 200 for producing an aerosol. Detecting user operation of the aerosol-generating device 200 may comprise detecting a user input, for example user activation of the aerosol-generating device 200. Additionally or alternatively, detecting user operation of the aerosol-generating device 200 may comprise detecting that an aerosol-generating article 100 has been inserted into the aerosol-generating device 200.

In response to detecting the user operation at step 910, the controller 330 enters a first user operation mode. During the first user operation mode, the controller 330 may be configured to perform, at step 920, the optional pre-heating process described above. At the end of the predetermined duration of the pre-heating process, the controller 330 is configured to perform the calibration process (step 930) as described above. Alternatively, during the first user operation mode, the controller 330 may be configured to proceed to step 930 without performing the pre-heating process. Following successful completion of the calibration process, the controller 330 enters the second user operation mode in which the aerosol is produced at step 940 for inhalation by the user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method for controlling aerosol production in an aerosol-generating device, the aerosol-generating device comprising an inductive heating arrangement and a power source configured to provide power to the inductive heating arrangement, the method comprising:
performing, during a first user operation mode of the aerosol-generating device for producing an aerosol, a calibration process comprising measuring, to obtain a first safety parameter value, a safety parameter associated with a susceptor inductively coupled to the inductive heating arrangement, wherein the susceptor is configured to heat an aerosol-forming substrate, wherein the calibration process further comprises a heating phase from a first calibration temperature to a second calibration temperature of the susceptor, and wherein the safety parameter is a duration of the heating phase; and
during a second user operation mode of the aerosol-generating device for producing the aerosol, controlling power provided to the inductive heating arrangement such that a temperature of the susceptor is adjusted based at least in part on the measured safety parameter.

17. The method according to claim 16,
further comprising performing one or more further calibration processes, the one or more further calibration processes comprising remeasuring the safety parameter associated with the susceptor,
wherein the step of controlling the power provided to the inductive heating arrangement such that the temperature of the susceptor is adjusted based at least in part on the measured safety parameter comprises:
determining whether a value of the safety parameter remeasured during a respective further calibration process is greater than a threshold value, the threshold value based at least in part on the first safety parameter value, and
if the value of the safety parameter remeasured during the respective further calibration process is greater than the threshold value, entering a safety operation mode of the aerosol-generating device.

18. The method according to claim 17, wherein the threshold value is at least 2 times the first safety parameter value.

19. The method according to claim 16,
further comprising performing one or more further calibration processes, the one or more further calibration processes comprising remeasuring the safety parameter associated with the susceptor,
wherein the step of controlling the power provided to the inductive heating arrangement such that the temperature of the susceptor is adjusted based at least in part on the measured safety parameter comprises:
determining whether a value of a safety parameter remeasured during a respective further calibration process is greater than a threshold value, the threshold value based at least in part on a value of the safety parameter measured during a last calibration process prior to the respective calibration process, and
if the value of the safety parameter remeasured during the respective further calibration process is greater than the threshold value, entering a safety operation mode of the aerosol-generating device.

20. The method according to claim 19, wherein the threshold value is at least 2 times a value of the safety parameter measured during the last calibration process prior to the respective calibration process.

21. The method according to claim 16, wherein the step of controlling the power provided to the inductive heating arrangement such that the temperature of the susceptor is adjusted based at least in part on the measured safety parameter comprises:
comparing the first safety parameter value to a predetermined value associated with the susceptor, and
entering a safety operation mode or entering the second user operation mode based on an outcome of the comparison.

22. The method according to claim 21, wherein the entering the safety operation mode or entering the second user operation mode based on the outcome of the comparison comprises:
entering the safety operation mode if the first safety parameter value is greater than the predetermined value, and
entering the second user operation mode if the first safety parameter value is less than the predetermined value.

23. The method according to claim 16, further comprising, during the second user operation mode of the aerosol-generating device for producing an aerosol, maintaining the temperature of the susceptor between the first calibration temperature and the second calibration temperature.

24. The method according to claim 16,
wherein the step of performing the calibration process further comprises measuring a first calibration value corresponding to the first calibration temperature and a second calibration value corresponding to the second calibration temperature,
wherein the first calibration value and the second calibration value are values of current, resistance values, or conductance values, and
wherein the step of controlling the power provided to the inductive heating arrangement comprises adjusting the temperature of the susceptor based at least in part on the first calibration value and the second calibration value.

25. An aerosol-generating device, comprising:
a power source configured to provide a DC supply voltage and a DC current; and
power supply electronics connected to the power source, the power supply electronics comprising:
a DC/AC converter,
an inductor connected to the DC/AC converter and being configured to generate an alternating magnetic field when energized by an alternating current from the DC/AC converter, the inductor being couplable to a susceptor, wherein the susceptor is configured to heat an aerosol-forming substrate, and
a controller configured to,
during a first user operation mode of the aerosol-generating device, perform a calibration process comprising measuring, to obtain a first safety parameter value, a safety parameter associated with a susceptor inductively coupled to the inductive heating arrangement, wherein the susceptor is configured to heat the aerosol-forming substrate, wherein the calibration process comprises a heating phase from a first calibration temperature to a second calibration temperature of the susceptor, and wherein the safety parameter is a duration of the heating phase, and
during a second user operation mode of the aerosol-generating device, control power provided to the inductive heating arrangement such that a temperature of the susceptor is adjusted based at least in part on the measured safety parameter.

26. The aerosol-generating device according to claim 25,
wherein the controller is further configured to perform one or more further calibration processes, the one or more further calibration processes comprising remeasuring the safety parameter associated with the susceptor, and
wherein controlling the power provided to the inductive heating arrangement such that the temperature of the susceptor is adjusted based at least in part on the measured safety parameter comprises:
determining whether a value of a safety parameter remeasured during a respective further calibration process is greater than a threshold value, the threshold value based at least in part on the first safety parameter value, and
if the value of the safety parameter remeasured during a respective further calibration process is greater than the threshold value, the controller is further configured to enter a safety operation mode of the aerosol-generating device.

27. The aerosol-generating device according to claim 26,
wherein the controller is further configured to perform one or more further calibration processes, comprising remeasuring the safety parameter associated with the susceptor, and
wherein controlling the power provided to the inductive heating arrangement such that the temperature of the susceptor is adjusted based at least in part on the measured safety parameter comprises:
determining whether a value of a safety parameter remeasured during a respective further calibration process is greater than a threshold value, the threshold value based at least in part on a value of a safety parameter measured during a last calibration process prior to the respective calibration process, and
if the value of the safety parameter remeasured during the respective further calibration process is greater than the threshold value, the controller is further configured to enter a safety operation mode of the aerosol-generating device.

28. The aerosol-generating device according to claim 26, wherein entering the safety operation mode comprises turning off the aerosol-generating device.

29. The aerosol-generating device according to claim 27, wherein entering the safety operation mode comprises turning off the aerosol-generating device.

30. The aerosol-generating device according to claim 25,
wherein the susceptor comprises a first susceptor material having a first Curie temperature and a second susceptor material having a second Curie temperature,
wherein the second Curie temperature is lower than the first Curie temperature, and
wherein the second calibration temperature corresponds to the second Curie temperature of the second susceptor material.

31. An aerosol-generating system, comprising:
the aerosol-generating device according to claim 25; and
an aerosol-generating article comprising the aerosol-forming substrate and the susceptor in thermal contact with the aerosol-forming substrate.
